(19) United States
(12) Patent Application Publication
(10) Pub. No.: US 2018/0218831 A1
(43) Pub. Date: Aug. 2, 2018

(54) COIL COMPONENT AND METHOD FOR MANUFACTURING COIL COMPONENT

(71) Applicant: SUMIDA CORPORATION, Tokyo (JP)

(72) Inventor: Hiroyuki Miyazaki, Natori City (JP)

(21) Appl. No.: 15/840,148

(22) Filed: Dec. 13, 2017

(30) Foreign Application Priority Data
Jan. 27, 2017 (JP) 2017-012701

(51) Int. Cl. H01F 27/32; H01F 27/28; H01F 41/061; H01F 41/098

(52) U.S. Cl. CPC H01F 27/325; H01F 41/098; H01F 41/061; H01F 27/2823

(57) ABSTRACT

A coil component includes an edgewise coil and a bobbin around which the edgewise coil is wound. The bobbin includes a tubular bobbin body, and plural position-limiting protruding portions arranged in plural portions on the outer peripheral surface of the bobbin body and limit the position of each winding portion of the edgewise coil in the axial direction of the bobbin body. The plural position-limiting protruding portions include first and second position-limiting protruding portions, which are disposed at different positions in the axial direction of the bobbin body. The edgewise coil includes a first winding portion that is in pressure contact with the first position-limiting protruding portion toward the second position-limiting protruding portion, and a second winding portion that is in pressure contact with the second position-limiting protruding portion toward the first position-limiting protruding portion.

### TECHNICAL FIELD

The present invention relates to coil components and methods for manufacturing a coil component.

### BACKGROUND ART

Japanese Patent Application Laid-open No. 2006-120767 describes a coil component including a core and a coil wound around the outer periphery of the coil, in which plural protruding portions, each of which is arranged between winding portions of the coil to determine the position of each winding portion, are formed integrally with the outer peripheral surface of the core.

This coil component is manufactured in the following manner.

First, the core is inserted into the coil in a state where the diameter of the coil is increased by twisting it in a radially expanding direction.

Then, twisting of the coil is released to make the diameter of the coil elastically return to the original diameter. At this time, each protruding portion of the core is arranged between individual winding portions of the coil. In this manner, the coil is wound around the outer periphery of the core.

In this way, changes in positions of each of the winding portions are limited in the axial direction of the coil by the plural protruding portions.

### SUMMARY OF THE INVENTION

According to the present invention, there is provided a coil component, which includes:

an edgewise coil; and

a bobbin around which the edgewise coil is wound, in which

the bobbin includes:
a tubular bobbin body; and
a plurality of position-limiting protruding portions arranged in a plurality of portions on an outer peripheral surface of the bobbin body and limiting a position of a winding portion of the edgewise coil in an axial direction of the bobbin body,

the plurality of position-limiting protruding portions include a first position-limiting protruding portion and a second position-limiting protruding portion that are disposed at positions different from each other in the axial direction of the bobbin body,

the edgewise coil includes:
a first winding portion that is in pressure contact with the first position-limiting protruding portion toward the second position-limiting protruding portion; and
a second winding portion that is in pressure contact with the second position-limiting protruding portion toward the first position-limiting protruding portion, and

the edgewise coil is in a state of space winding in which respective winding portions from the first winding portion to the second winding portion are spaced apart from each other in the axial direction of the bobbin body.

Furthermore, according to the present invention, there is provided a method for manufacturing a coil component by winding an edgewise coil around a bobbin, the method including:

preparing a bobbin including:
a tubular bobbin body; and
a plurality of position-limiting protruding portions arranged in a plurality of portions on an outer peripheral surface of the bobbin body and limiting a position of each winding portion of the edgewise coil in an axial direction of the bobbin body,
the plurality of position-limiting protruding portions including a first position-limiting protruding portion and a second position-limiting protruding portion that are disposed at positions different from each other in the axial direction of the bobbin body; and

winding the edgewise coil around the bobbin by screwing the bobbin and the edgewise coil with each other, in a manner such that:
the edgewise coil includes:
   a first winding portion that is in pressure contact with the first position-limiting protruding portion toward the second position-limiting protruding portion; and
   a second winding portion that is in pressure contact with the second position-limiting protruding portion toward the first position-limiting protruding portion, and
the edgewise coil is in a state of space winding in which respective winding portions from the first winding portion to the second winding portion are spaced apart from each other in the axial direction of the bobbin body.

According to the present invention, the edgewise coil includes the first winding portion that is in pressure contact with the first position-limiting protruding portion toward the second position-limiting protruding portion and the second winding portion that is in pressure contact with the second position-limiting protruding portion toward the first position-limiting protruding portion. In addition, the edgewise coil is in the state of space winding where respective winding portions from the first winding portion to the second winding portion are spaced apart from each other in the axial direction of the bobbin body. With such a structure, it is possible to stably assemble the edgewise coil to the bobbin, and stably maintain the positions of the winding portions of the coil.

### BRIEF DESCRIPTION OF THE DRAWINGS

FIG. 1 is a perspective view illustrating a coil that a coil component according to the first exemplary embodiment has.

FIG. 2 is a perspective view illustrating a bobbin that the coil component according to the first exemplary embodiment has.

FIG. 3 is a plan view illustrating the bobbin that the coil component according to the first exemplary embodiment has.

FIG. 4 is an elevation view illustrating the bobbin that the coil component according to the first exemplary embodiment has, showing the shape of the bobbin as viewed in the direction of the arrow A in FIG. 2.

FIG. 5 is a perspective view illustrating a core that the coil component according to the first exemplary embodiment has.

FIG. 6 is a front sectional view illustrating the core that the coil component according to the first exemplary embodiment has.

FIG. 7 is a perspective view illustrating the coil component according to the first exemplary embodiment.

FIG. 8 is an elevation view illustrating the coil component according to the first exemplary embodiment.

FIG. 9 is a front sectional view illustrating the coil component according to the first exemplary embodiment.

FIG. 10 is a front sectional view illustrating a coil component according to a modification example of the first exemplary embodiment.

FIG. 11 is a perspective view illustrating a coil component unit including the coil component according to the first exemplary embodiment.

FIG. 12 is a sectional plan view illustrating the coil component unit including the coil component according to the first exemplary embodiment.

FIG. 13 is an explanatory view illustrating a method for manufacturing the coil component according to the first exemplary embodiment.

FIG. 14 is a perspective view illustrating a core that a coil component according to a second exemplary embodiment has.

FIG. 15 is a front sectional view illustrating the core that the coil component according to the second exemplary embodiment has.

### DESCRIPTION OF EMBODIMENTS

However, as a result of studies made by the present inventor, there are rooms for improvement in the technique described in Japanese Patent Application Laid-open No. 2006-120767 in terms of stability of the position of each of the winding portions in the axial direction of the coil.

The present invention has been made in view of the problem described above, and is to provide a coil component having a structure that can more stably maintain the position of each winding portion of the coil, and also provide a method for manufacturing the coil component.

The above and other objects, advantages and features of this invention will be more apparent from the following description of certain preferred embodiments taken in conjunction with the accompanying drawings.

Hereinbelow, exemplary embodiments according to the present invention will be described with reference to the drawings. Note that, in all the drawings, the same reference characters are attached to similar constituent components, and detailed explanation thereof will not be repeated as appropriate.

### First Exemplary Embodiment

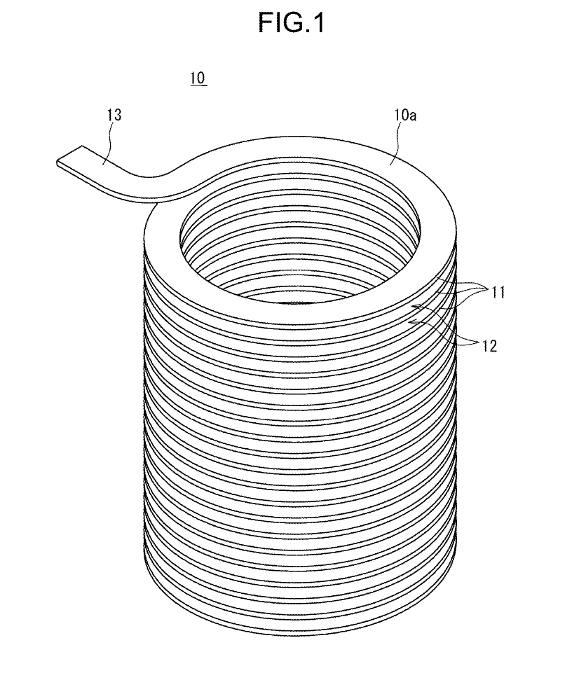

First, a coil component 40 according to this exemplary embodiment will be described with reference to FIGS. 1 to 10.

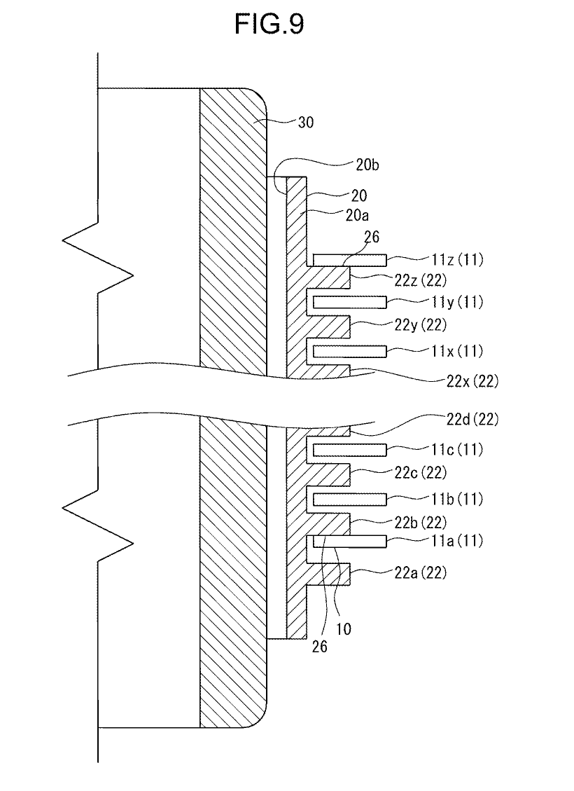

The coil component 40 according to this exemplary embodiment includes an edgewise coil 10 and a bobbin 20 around which the edgewise coil 10 is wound. The bobbin 20 includes a tubular bobbin body 20a, and a plurality of position-limiting protruding portions (for example, plural position-limiting protruding portions 21, plural position-limiting protruding portions 22, plural position-limiting protruding portions 23, and plural position-limiting protruding portions 24) that are arranged in a plurality of portions on an outer peripheral surface of the bobbin body 20a and limit the position of each winding portion 11 of the edgewise coil 10 in the axial direction of the bobbin body 20a. The plurality of position-limiting protruding portions include a first position-limiting protruding portion (for example, a position-limiting protruding portion 22b illustrated in FIG. 9 and so on) and a second position-limiting protruding portion (for example, a position-limiting protruding portion 22z illustrated in FIG. 9 and so on) that are disposed at positions different from each other in the axial direction of the bobbin body 20a. The edgewise coil 10 includes a first winding portion (for example, a winding portion 11a illustrated in FIG. 9) that is in pressure contact with the first position-limiting protruding portion toward the second position-limiting protruding portion, and a second winding portion (for example, a winding portion 11z illustrated in FIG. 9) that is in pressure contact with the second position-limiting protruding portion toward the first position-limiting protruding portion. The edgewise coil 10 is in a state of space winding in which respective winding portions 11 from the first winding portion to the second winding portion are spaced apart from each other in the axial direction of the bobbin body 20a.

Here, the space winding represents a way of winding which is also called pitch winding.

Furthermore, each of the winding portions 11 is a portion of the edgewise coil 10 that makes one round around the bobbin 20, and the edgewise coil 10 is an assembly of plural winding portions 11 arranged seamlessly in a spiral shape.

In addition, the first position-limiting protruding portion and the second position-limiting protruding portion may be arranged alongside each other in the axial direction of the bobbin body 20a, or may be arranged alongside each other in a direction intersecting the axial direction. Moreover, the direction of the second position-limiting protruding portion with respect to the first position-limiting protruding portion (the direction in which the first winding portion is in pressure contact with the first position-limiting protruding portion) and the direction of the first position-limiting protruding portion with respect to the second position-limiting protruding portion (the direction in which the second winding portion is in pressure contact with the second position-limiting protruding portion) may be the axial direction of the bobbin body 20a, or may be the direction intersecting this axial direction.

In the case of the coil component 40 according to this exemplary embodiment, the edgewise coil 10 is in a state of space winding in which respective winding portions 11 from the first winding portion to the second winding portion are spaced apart from each other in the axial direction of the bobbin body 20a. This configuration enables a stray capacity and a proximity effect between winding portions 11 to be reduced, and hence, it is possible to obtain the coil component 40 with high quality factor, and also possible to reduce the size of the coil component 40. Furthermore, the coil component 40 is configured so as to include the edgewise coil 10 using a rectangular wire, and hence, it is possible to reduce the skin effect. In addition, since individual winding portions 11 are space apart from each other, it is possible to achieve a favorable heat dissipation property.

Furthermore, the first winding portion of the edgewise coil 10 is in pressure contact with the first position-limiting protruding portion toward the second position-limiting protruding portion, and at the same time, the second winding portion of the edgewise coil 10 is in pressure contact with the second position-limiting protruding portion toward the first position-limiting protruding portion. With this configuration, it is possible to stably determine the positions of the first winding portion and the second winding portion with respect to the first position-limiting protruding portion and the second position-limiting protruding portion, respectively. Thus, it is possible to more stably maintain the position of each of the winding portions 11 of the edgewise coil 10.

The coil component 40 according to this exemplary embodiment can be favorably used as a resonance coil for a field coupling non-contact power supply system, can be used at high frequencies (for example, a band of MHz) and with large electric power (the order of kw or higher), and has a structure that has reduced loss. In such a resonance coil, the alternating-current resistance due to stray capacity, proximity effect and core loss causes a large loss. However, in the case of the coil component 40 according to this exemplary embodiment, the stray capacity and the proximity effect between winding portions 11 can be reduced, so that the alternating-current resistance can be suppressed. In addition, the edgewise coil 10 configured with a rectangular wire is used to increase the surface area of the edgewise coil 10, so that the skin effect can be reduced. Thus, it is possible to obtain a resonance coil having an excellent quality factor.

That is, in the case of the coil component 40 according to this exemplary embodiment, although inductance is reduce, the capacitance can be largely reduced, and hence, it is possible to obtain sufficient quality factor. Furthermore, the edgewise coil 10 having a favorable heat dissipation property can be obtained.

Below, detailed description will be given.

As illustrated in FIG. 1, the edgewise coil 10 is formed by spirally winding a metal wire 10a, which is a rectangular wire, and has plural winding portions 11. The winding portions 11 each have a winding diameter equivalent to each other.

The edgewise coil 10 has an outwardly extending piece 13 at both ends thereof.

The edgewise coil 10 may be configured such that, before wound around the bobbin 20, adjacent winding portions 11 may be in contact with each other (for example, the edgewise coil 10 may be tightly wound in a manner such that no space 12 exists between adjacent winding portions 11).

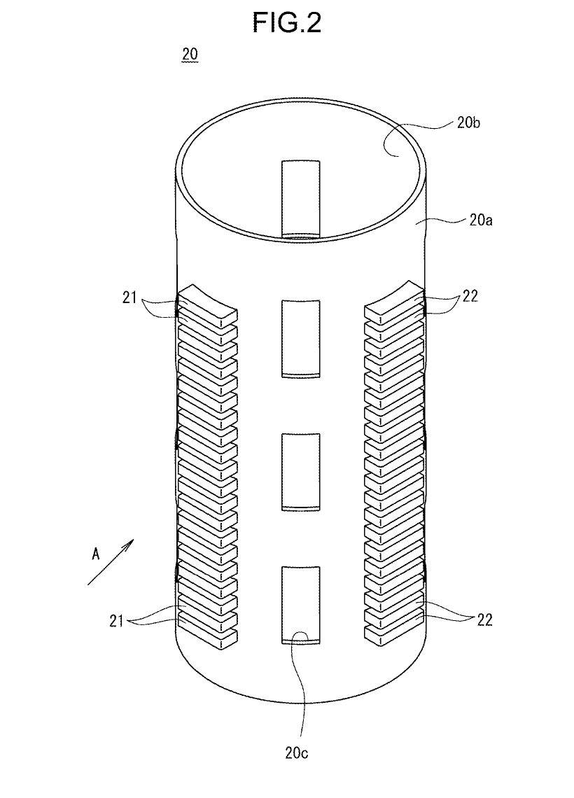

As illustrated in any of FIGS. 2 to 4, the bobbin 20 includes a tubular bobbin body 20a, and plural position-limiting protruding portions arranged in plural portions on the outer peripheral surface of the bobbin body 20a.

In the case of this exemplary embodiment, the position-limiting protruding portions are arranged in a plurality of portions in the circumferential direction of the bobbin body 20a (in a direction around the axial center of the bobbin body 20a).

In addition, a plurality of the position-limiting protruding portions are arranged alongside each other along the axial direction of the bobbin body 20a at each of the plurality of portions in the circumferential direction of the bobbin body 20a.

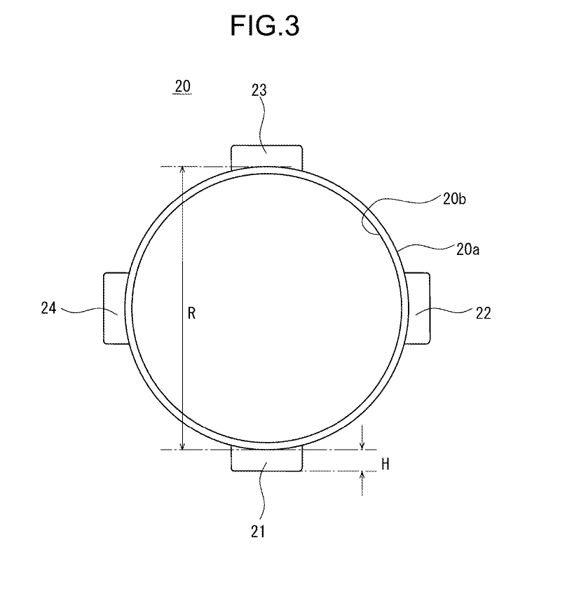

More specifically, on the outer peripheral surface of the bobbin body 20a, plural position-limiting protruding portions 21, plural position-limiting protruding portions 22, plural position-limiting protruding portions 23 (see FIG. 3), and plural position-limiting protruding portions 24 are arranged.

The plural position-limiting protruding portions 21 are arranged alongside each other along the axial direction of the bobbin body 20a at one position in the circumferential direction of the bobbin body 20 a.

In a portion positionally shifted by 90 degrees in the circumferential direction of the bobbin body 20a from the portion where the plural position-limiting protruding portions 21 are arranged, the plural position-limiting protruding portions 22 are arranged alongside each other along the axial direction of the bobbin body 20a.

In a portion positionally shifted by 180 degrees in the circumferential direction of the bobbin body 20a from the portion where the plural position-limiting protruding portions 21 are arranged, the plural position-limiting protruding portions 23 are arranged alongside each other along the axial direction of the bobbin body 20a.

In a portion positionally shifted by 180 degrees in the circumferential direction of the bobbin body 20a from the portion where the plural position-limiting protruding portions 22 are arranged, the plural position-limiting protruding portions 24 are arranged alongside each other along the axial direction of the bobbin body 20a.

In this way, plural position-limiting protruding portions are arranged respectively at positions equiangularly spaced apart in the circumferential direction of the bobbin body 20a.

For example, the number of the position-limiting protruding portions 21, the number of the position-limiting protruding portions 22, the number of the position-limiting protruding portions 23, and the number of the position-limiting protruding portions 24 are equal to each other.

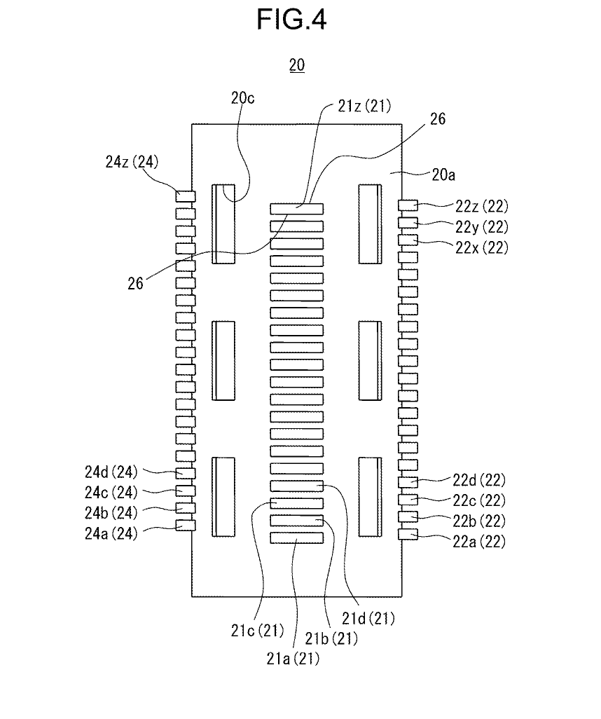

The bobbin 20 includes a position-limiting protruding portion 21a, a position-limiting protruding portion 21b, a position-limiting protruding portion 21c, and a position-limiting protruding portion 21d in the order they appear from the bottom in FIG. 4, each of which serves as the position-limiting protruding portion 21.

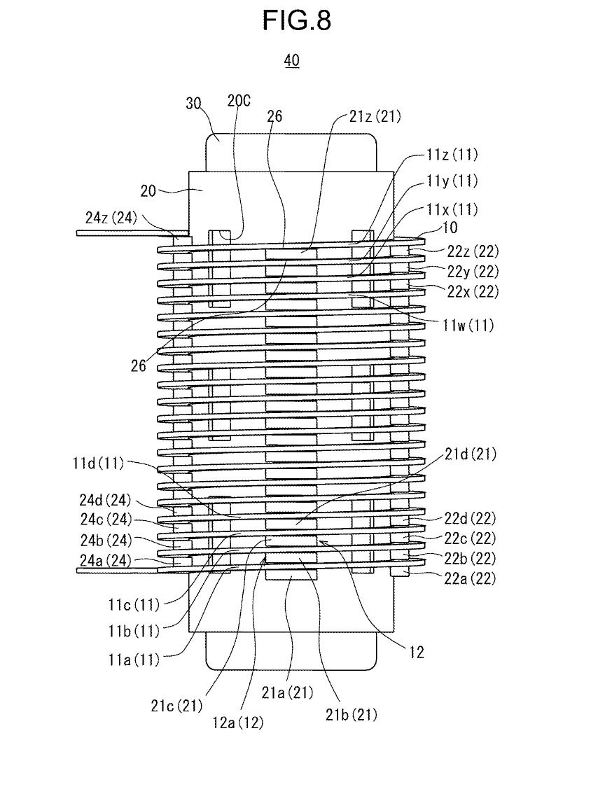

Similarly, the bobbin 20 includes a position-limiting protruding portion 22a, a position-limiting protruding portion 22b, a position-limiting protruding portion 22c, and a position-limiting protruding portion 22d in the order they appear from the bottom in FIG. 8, each of which serves as the position-limiting protruding portion 22.

Similarly, the bobbin 20 includes a position-limiting protruding portion 23a (not illustrated), a position-limiting protruding portion 23b (not illustrated), a position-limiting protruding portion 23c (not illustrated), and a position-limiting protruding portion 23d (not illustrated) in the order from bottom to top in FIG. 8, each of which serves as the position-limiting protruding portion 23. Here, the reference characters 23a, 23b, 23c, and 23d are reference characters used for convenience sake and not illustrated in the drawings.

Similarly, the bobbin 20 includes a position-limiting protruding portion 24a, a position-limiting protruding portion 24b, a position-limiting protruding portion 24c, and a position-limiting protruding portion 24d in the order they appear from the bottom in FIG. 8, each of which serves as the position-limiting protruding portion 24.

In addition, the bobbin 20 includes a position-limiting protruding portion 22z, a position-limiting protruding portion 22y, and a position-limiting protruding portion 22x in the order they appear from the top in FIG. 8, each of which serves as the position-limiting protruding portion 22.

Furthermore, the bobbin 20 includes a position-limiting protruding portion 21z serving as the position-limiting protruding portion 21 and located at the uppermost position in FIG. 8.

Similarly, the bobbin 20 includes a position-limiting protruding portion 23z (not illustrated) serving as the position-limiting protruding portion 23 and located at the uppermost position in FIG. 8. Here, the reference character 23z is a reference character used for convenience sake and not illustrated in the drawings.

Similarly, the bobbin 20 includes a position-limiting protruding portion 24z serving as the position-limiting protruding portion 24 and located at the uppermost position in FIG. 8.

In FIG. 4, the position-limiting protruding portion 22a is disposed at a position higher than the position-limiting protruding portion 21a; the position-limiting protruding portion 23a (not illustrated) is disposed at a position higher than the position-limiting protruding portion 22a; the position-limiting protruding portion 24a is disposed at a position higher than the position-limiting protruding portion 23a; and the position-limiting protruding portion 21b is disposed at a position higher than the position-limiting protruding portion 24a.

Here, in the axial direction of the bobbin body 20a, the distance between the position-limiting protruding portion 21a and the position-limiting protruding portion 22a, the distance between the position-limiting protruding portion 22a and the position-limiting protruding portion 23a, the distance between the position-limiting protruding portion 23a and the position-limiting protruding portion 24a, and the distance between the position-limiting protruding portion 24a and the position-limiting protruding portion 21b are, for example, one quarter of the distance between the position-limiting protruding portion 21a and the position-limiting protruding portion 21b.

In addition, the position-limiting protruding portions 21 are each arranged at equal intervals in the axial direction of the bobbin body 20a.

Similarly, the position-limiting protruding portions 22 are each arranged at equal intervals in the axial direction of the bobbin body 20a.

Similarly, the position-limiting protruding portions 23 are each arranged at equal intervals in the axial direction of the bobbin body 20a.

Similarly, the position-limiting protruding portions 24 are each arranged at equal intervals in the axial direction of the bobbin body 20a.

Furthermore, the distance between adjacent position-limiting protruding portions 21, the distance between adjacent position-limiting protruding portions 22, the distance between adjacent position-limiting protruding portions 23, and the distance between adjacent position-limiting protruding portions 24 are equal to each other.

Thus, the position-limiting protruding portions of the bobbin 20 are arranged alongside each other along the spirally shaped path in the following order: the position-limiting protruding portion 21a, the position-limiting protruding portion 22a, the position-limiting protruding portion 23a, the position-limiting protruding portion 24a, the position-limiting protruding portion 21b, the position-limiting protruding portion 22b, the position-limiting protruding portion 23b, the position-limiting protruding portion 24b, the position-limiting protruding portion 21c, . . . .

As described above, the plurality of position-limiting protruding portions of the bobbin 20 are arranged along the spirally shaped path.

In the case of this exemplary embodiment, each of the position-limiting protruding portions is a rib elongated in the circumferential direction of the bobbin body 20a. That is, the position-limiting protruding portions each have the shape in which the size of each of the position-limiting protruding portions in the circumferential direction of the bobbin body 20a is larger than the size of each of the position-limiting protruding portions in the axial direction of the bobbin body 20a.

More specifically, the position-limiting protruding portions each have a pair of orthogonal surfaces 26 orthogonal to the axial direction of the bobbin body 20a. That is, in FIG. 4, the surface on the bottom side and the surface on the top side of each of the position-limiting protruding portions each serve as the orthogonal surface 26 (in FIG. 4, the reference character of the orthogonal surface 26 is attached only to the position-limiting protruding portion 21z).

As described above, the plural position-limiting protruding portions each have the orthogonal surfaces 26, each of which is orthogonal to the axial direction of the bobbin body 20a. The orthogonal surfaces 26 are formed into a flat plane shape.

The shape and the size of each of the position-limiting protruding portions are set, for example, so as to be equivalent to each other.

In the bobbin body 20a, for example, one or a plurality of openings 20c penetrating the inside and the outside of the bobbin main body 20a are formed. That is, a hollow portion 20b, which is the inside space of the bobbing body 20a, and the external space of the bobbin body 20a are communicated with each other through each of the opening 20c.

For example, in the circumferential direction of the bobbin body 20a, plural openings 20c are arranged respectively between the line of the plural position-limiting protruding portions 21 and the line of the plural position-limiting protruding portions 22, between the line of the plural position-limiting protruding portions 22 and the line of the plural position-limiting protruding portions 23, between the line of the plural position-limiting protruding portions 23 and the line of the plural position-limiting protruding portions 24, and between the line of the plural position-limiting protruding portions 24 and the line of the plural position-limiting protruding portions 21.

For example, the entire bobbin 20 including the bobbin body 20a and the plural position-limiting protruding portions (the plural position-limiting protruding portions 21, the plural position-limiting protruding portions 22, the plural position-limiting protruding portions 23, and the plural position-limiting protruding portions 24) is formed integrally using resin or other insulating, non-magnetic material.

In this exemplary embodiment, description is made of an example in which plural position-limiting protruding portions are arranged in each of four portions located in the circumferential direction of the bobbin body 20a. However, the present invention is not limited to this example. It may be possible that plural position-limiting protruding portions are arranged in each of two or three portions in the circumferential direction of the bobbin body 20a, or it may be possible that plural position-limiting protruding portions are arranged in each of five or more portions in the circumferential direction of the bobbin body 20a.

Furthermore, the present invention is not limited to the example in which position-limiting protruding portions are arranged in each of plural portions in the circumferential direction of the bobbin body 20a. It may be possible to employ a configuration in which plural position-limiting protruding portions are arranged in only one portion in the circumferential direction of the bobbin body 20a.

In addition, the present invention is not limited to the example in which plural position-limiting protruding portions are arranged alongside each other along the axial direction of the bobbin body 20a in each of plural portions located in the circumferential direction of the bobbin body 20a. It may be possible to employ a configuration in which one position-limiting protruding portion is disposed in each of plural portions located in the circumferential direction of the bobbin body 20a.

Moreover, the present invention is not limited to the example in which plural position-limiting protruding portions are arranged on the outer peripheral surface of the bobbin body 20a. It may be possible to employ a configuration in which one spirally shaped position-limiting protruding portion (rib) is formed on the outer peripheral surface of the bobbin body 20a. In this case, each part of the spirally shaped position-limiting protruding portion constitutes the first position-limiting protruding portion and the second position-limiting protruding portion.

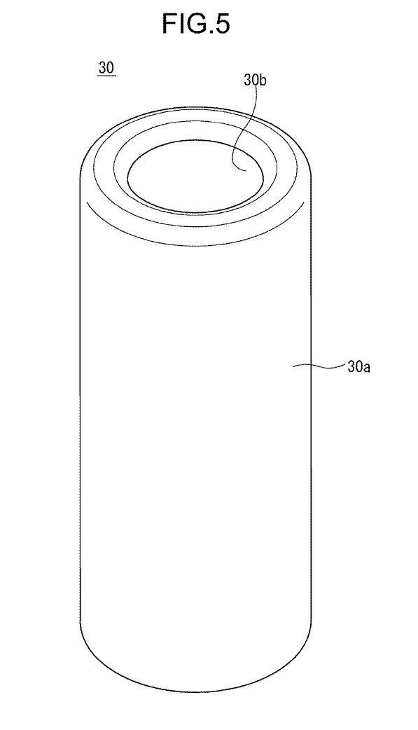

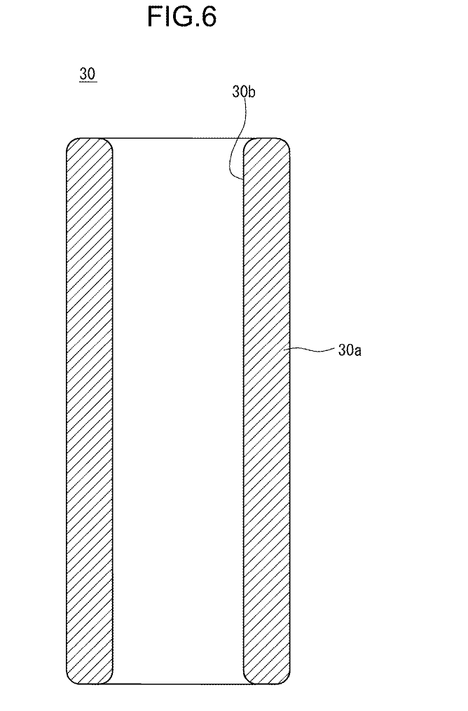

As illustrated in FIGS. 5 and 6, in the case of this exemplary embodiment, the core 30 is comprised of a tubular core body 30a. On the inner side of the core body 30a, a cylindrical hollow portion 30b is formed.

The outer diameter of the core 30 is smaller than the inner diameter of the bobbin body 20a.

Here, H (see FIG. 3) represents the projection length of the position-limiting protruding portion outward from the outer peripheral surface of the bobbin body 20a in the radial direction of the bobbin body 20a (the size of height of the position-limiting protruding portion), and R (see FIG. 3) represents the outer diameter of the bobbin body 20a. The inner diameter of the edgewise coil 10 is larger than the outer diameter R of the bobbin body 20a, and preferably, is less than (R+2H). In addition, it may be possible to set the inner diameter of the edgewise coil 10 to be less than (R+H). By setting the inner diameter of the edgewise coil 10 so as to be less than (R+2H), it is possible to more reliably engage the winding portions 11 of the edgewise coil 10 with the position-limiting protruding portions.

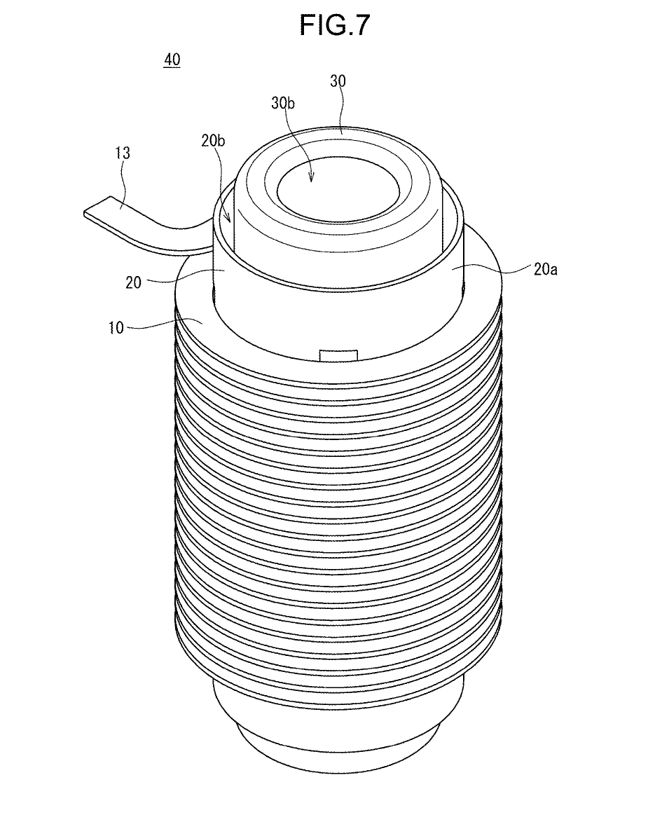

As illustrated in FIGS. 7 and 8, the coil component 40 is configured by winding the edgewise coil 10 around the bobbin body 20a and inserting the core 30 into the hollow portion 20b of the bobbin 20.

As illustrated in FIG. 8, each of the winding portions 11 of the edgewise coil 10 is disposed between position-limiting protruding portions adjacent to each other in the axial direction of the bobbin body 20a.

Here, the edgewise coil 10 includes a winding portion 11a, a winding portion 11b, a winding portion 11c, and a winding portion 11d in the order they appear from the bottom in FIG. 8.

Furthermore, the edgewise coil 10 includes a winding portion 11z, a winding portion 11y, a winding portion 11x, and a winding portion 11w in the order they appear from the top in FIG. 8.

Of these winding portions, the winding portion 11a passes through, for example, between the position-limiting protruding portion 21a and the position-limiting protruding portion 21b, between the position-limiting protruding portion 22a and the position-limiting protruding portion 22b, and between the position-limiting protruding portion 23a (not illustrated) and the position-limiting protruding portion 23b (not illustrated), and then, reaches a portion between the position-limiting protruding portion 24a and the position-limiting protruding portion 24b.

Similarly, the winding portion 11b passes through between the position-limiting protruding portion 21b and the position-limiting protruding portion 21c, between the position-limiting protruding portion 22b and the position-limiting protruding portion 22c, and between the position-limiting protruding portion 23b (not illustrated) and the position-limiting protruding portion 23c (not illustrated), and then, reaches a portion between the position-limiting protruding portion 24b and the position-limiting protruding portion 24c.

Similarly, the winding portion 11c passes through between the position-limiting protruding portion 21c and the position-limiting protruding portion 21d, between the position-limiting protruding portion 22c and the position-limiting protruding portion 22d, and between the position-limiting protruding portion 23c (not illustrated) and the position-limiting protruding portion 23d (not illustrated), and then, reaches a portion between the position-limiting protruding portion 24c and the position-limiting protruding portion 24d.

Other winding portions 11 of the edgewise coil 10 similarly pass sequentially through between position-limiting protruding portions adjacent to each other in the axial direction of the bobbin 20.

Thus, the path of the wire 10a forming the edgewise coil 10 is limited to the spirally shaped path by the plural position-limiting protruding portions of the bobbin 20.

In addition, a space 12 exists between winding portions 11 adjacent to each other of the edgewise coil 10. In other words, the edgewise coil 10 is in a state of space winding (in a state of pitch winding).

More specifically, for example, as illustrated in FIG. 9, the winding portion 11a of the edgewise coil 10 is in pressure contact with the position-limiting protruding portion 22b toward the top side in FIG. 9 (in other words, toward the position-limiting protruding portion 22z). Meanwhile, the winding portion 11z of the edgewise coil 10 is in pressure contact with the position-limiting protruding portion 22z toward the bottom side in FIG. 9 (in other words, toward the position-limiting protruding portion 22b).

In addition, the winding portion 11a of the edgewise coil 10 is in pressure contact with the position-limiting protruding portion 21b towards the position-limiting protruding portion 21z, although no detailed illustration is given. Meanwhile, the winding portion 11z of the edgewise coil 10 is in pressure contact with the position-limiting protruding portion 21z toward the position-limiting protruding portion 21b.

Furthermore, although no illustration is given, the winding portion 11a of the edgewise coil 10 is in pressure contact with the position-limiting protruding portion 23b toward the position-limiting protruding portion 23z. Meanwhile, the winding portion 11z of the edgewise coil 10 is in pressure contact with the position-limiting protruding portion 23z toward the position-limiting protruding portion 23b.

Moreover, although no detailed illustration is given, the winding portion 11a of the edgewise coil 10 is in pressure contact with the position-limiting protruding portion 24b toward the position-limiting protruding portion 24z. Meanwhile, the winding portion 11z of the edgewise coil 10 is in pressure contact with the position-limiting protruding portion 24z toward the position-limiting protruding portion 24b.

As described above, the plural position-limiting protruding portions include the first position-limiting protruding portion (for example, the position-limiting protruding portion 21b, 22b, 23b, 24b) and the second position-limiting protruding portion (the position-limiting protruding portion 21z, 22z, 23z, 24z) that are disposed at positions different from each other in the axial direction of the bobbin body 20a. In addition, the edgewise coil 10 includes the first winding portion (for example, the winding portion 11a) that is in pressure contact with the first position-limiting protruding portion toward the second position-limiting protruding portion, and the second winding portion (for example, the winding portion 11z) that is in pressure contact with the second position-limiting protruding portion toward the first position-limiting protruding portion.

More specifically, the first winding portion (for example, the winding portion 11a) is in pressure contact with the orthogonal surface 26 (in particular, the surface on the bottom side of the first position-limiting protruding portion in FIGS. 8 and 9) of the first position-limiting protruding portion (for example, the position-limiting protruding portion 21b, 22b, 23b, 24b), and the second winding portion (for example, the winding portion 11z) is in pressure contact with the orthogonal surface 26 (in particular, the surface on the top side of the second position-limiting protruding portion in FIGS. 8 and 9) of the second position-limiting protruding portion.

Thus, the first winding portion and the second winding portion are substantially in surface contact with the first position-limiting protruding portion and the second position-limiting protruding portion, respectively.

This configuration more reliably reduces the positional displacement of the first winding portion and the second winding portion relative to the first position-limiting protruding portion and the second position-limiting protruding portion, respectively.

In addition, the winding portions 11 (for example, the winding portion 11b, 11c, 11x, 11y and the like illustrated in FIG. 9) other than the first winding portion (for example, the winding portion 11a) and the second winding portion (for example, the winding portion 11z) are disposed, for example, between position-limiting protruding portions 21 adjacent to each other in the axial direction of the bobbin body 20a, between position-limiting protruding portions 22 adjacent to each other in the axial direction of the bobbin body 20a, between position-limiting protruding portions 23 adjacent to each other in the axial direction of the bobbin body 20a, and between position-limiting protruding portions 24 adjacent to each other in the axial direction of the bobbin body 20a, respectively, and are not in contact with any of position-limiting protruding portions.

With this configuration, winding portions 11 from the first winding portion (for example, the winding portion 11a) to the second winding portion (for example, the winding portion 11z) are arranged equally (substantially at equal intervals) in the axial direction of the bobbin body 20a.

However, it may be possible that part of the winding portions 11 other than the first winding portion (for example, the winding portion 11a) and the second winding portion (for example, the winding portion 11z) is in contact with any of position-limiting protruding portions.

In the example illustrated in FIGS. 8 and 9, surplus position-limiting protruding portions 21, 22, and 23 (the position-limiting protruding portions 21a, 22a, 23a (not illustrated)) exist on one side (the bottom side) of the bobbin body 20a in the axial direction. However, these surplus position-limiting protruding portions may not exist.

In addition, surplus position-limiting protruding portions may exist on both sides of the bobbin body 20a in the axial direction.

Description has been made with reference to FIG. 9 of an example in which the winding portions 11 (winding portions 11a and 11z) on both ends of the edgewise coil 10 are each in pressure contact with the position-limiting protruding portion. However, it may be possible that a surplus winding portion 11 exists on both sides or one side of the edgewise coil 10, and a winding portion 11 that is not an end portion of the edgewise coil 10 is in pressure contact with a position-limiting protruding portion.

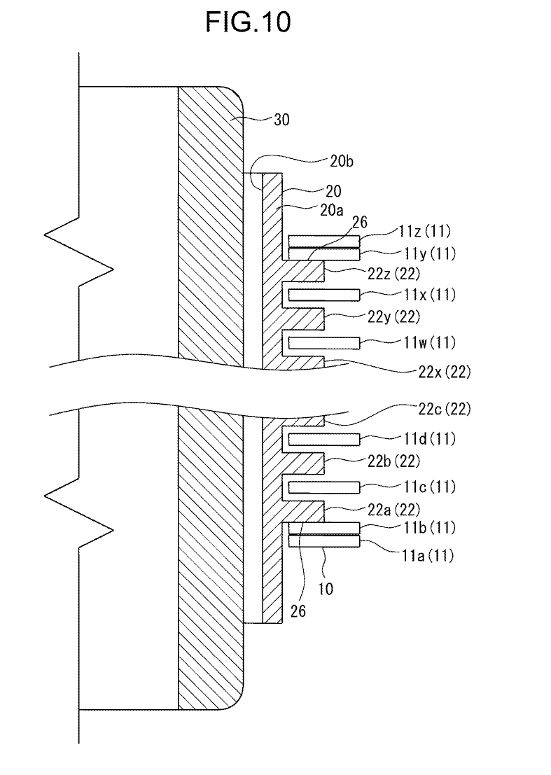

That is, for example, as illustrated in FIG. 10, it may be possible that the winding portion 11b is in pressure contact with the position-limiting protruding portion 22a toward the position-limiting protruding portion 22z, and the winding portion 11y is in pressure contact with the position-limiting protruding portion 22z toward the position-limiting protruding portion 22a. In this case, the winding portion 11b serves as the first winding portion, and the winding portion 11y serves as the second winding portion. In addition, the position-limiting protruding portion 22a serves as the first position-limiting protruding portion, and the position-limiting protruding portion 22z serves as the second position-limiting protruding portion.

In this case, a surplus winding portion 11 may be tightly wound in a manner such that the excess winding portion 11 is in close contact with an adjacent winding portion 11. At least, in the axial direction of the bobbin body 20a, the space between a surplus winding portion 11 and a winding portion 11 adjacent to the surplus winding portion 11 is narrower than each of the spaces between winding portions 11 adjacent to each other of the winding portions from the first winding portion to the second winding portion.

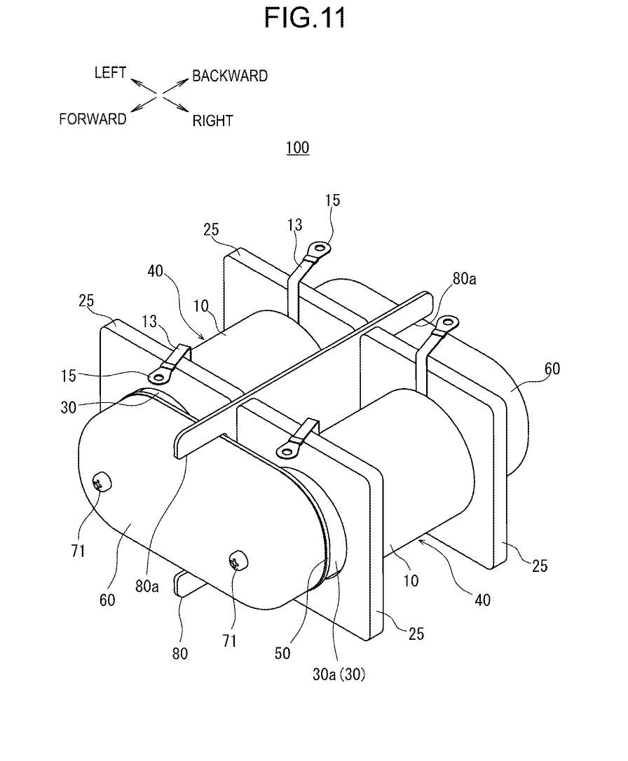

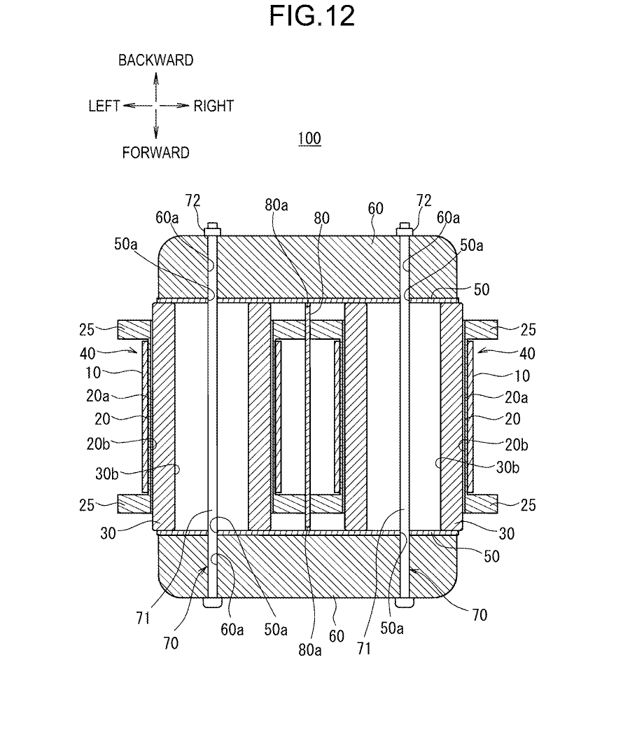

FIGS. 11 and 12 are diagrams each illustrating a coil component unit 100 formed by making plural (for example, two) coil components 40 into a unit. FIG. 11 is a perspective view and FIG. 12 is a sectional plan view. As for the positional relationship of the coil component unit 100 in each of FIGS. 11 and 12, the directions of forward, backward, left, and right are shown in each drawing. These directions are used only to illustrate the structure of the coil component unit 100, and do not necessarily correspond to the positional relationships of the coil component unit 100 during manufacturing or when in use.

Here, in FIGS. 2 to 4 and FIGS. 7 to 10, a flange portion 25 (see FIGS. 11 and 12) of the bobbin 20 is not illustrated. However, the bobbin 20 includes a pair of flange portions 25 each provided on both ends of the bobbin body 20a in the axial direction. The flange portion 25 is formed into a rectangular shape such as a square shape.

In addition, as illustrated in FIGS. 7, 8, and 12, in the axial direction of the bobbin body 20a, the longitudinal dimension of the core 30 is longer than that of the bobbin 20, and the end portion of the core 30 protrudes from each end of the bobbin 20.

Here, the two coil components 40 of the coil component unit 100 are arranged in parallel so that the axial directions of bobbin bodies 20a of these coil components 40 extend in parallel to each other.

In addition, a flat plate-like partitioning plate 80 is disposed between the two coil components 40.

In the axial direction of the bobbin body 20a, both ends of the partitioning plate 80 are each provided with a cutout-shaped portion 80a having a shape obtained by cutting out a rectangular-shaped portion from the partitioning plate 80.

As illustrated in FIG. 12, a flat plate-like spacer 50 is disposed at both ends of the coil component 40 in the axial direction of the bobbin body 20a.

In addition, a holding member 60 is disposed at positions located outside of the spacer 50 in the axial direction of the bobbin body 20a (at a position located in front of the forward-side spacer 50 in FIG. 12 and at a position located behind the backward-side spacer 50 in FIG. 12).

That is, the coil component unit 100 includes a pair of spacers 50 and a pair of holding members 60.

Each of the holding members 60 and the spacers 50 is used to fix both of the two coil components 40 of the coil component unit 100.

The spacers 50 and the holding members 60 each have an insertion hole 50a and an insertion hole 60a, respectively, formed therein. A bolt 71 is inserted into the insertion hole 50a and the insertion hole 60a of each of the spacers 50 and the holding members 60, respectively, located at both ends of the coil components 40 and also into the hollow portion 30b of the core 30. A nut 72 is tightened at the tip end side of the bolt 71. With this configuration, a pair of holding members 60, a pair of spacers 50, and the coil components 40 are fixed to each other with a fastening member 70 including the bolt 71 and the nut 72.

That is, by fastening the bolt 71 and the nut 72 together, both ends of the core 30 are sandwiched by the pair of holding members 60 via the spacers 50, respectively.

The spacer 50 on one side and a holding member 60 adjacent to this spacer 50 are disposed so as to penetrate through a plate surface of the partitioning plate 80 through the cutout-shaped portion 80a on one side (penetrate in the right and left direction in FIG. 11 and FIG. 12).

Similarly, the spacer 50 on the other side and a holding member 60 adjacent to this spacer 50 are disposed so as to penetrate through a plate surface of the partitioning plate 80 through the cutout-shaped portion 80a on the other side (penetrate in the right and left direction in FIG. 11 and FIG. 12).

In addition, a terminal portion 15 for external connection is provided at the outwardly extending pieces 13 at both ends of the edgewise coil 10 of each of the coil components 40.

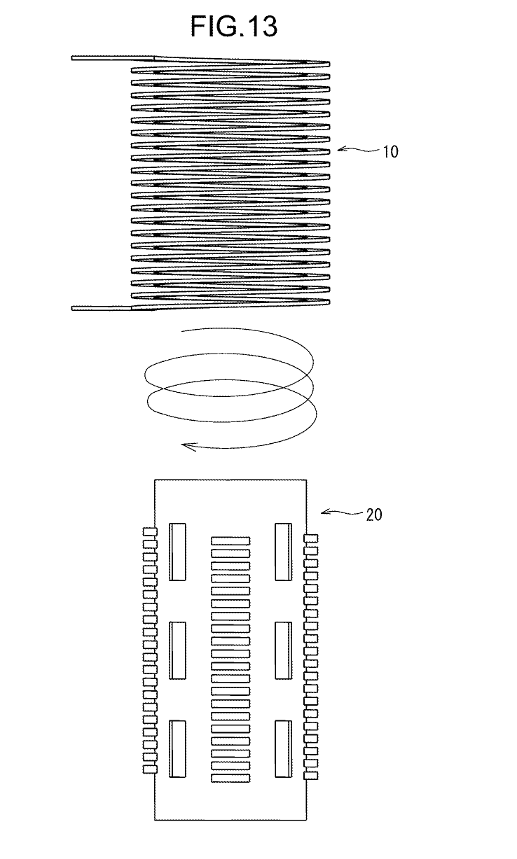

The coil component 40 according to this exemplary embodiment can be manufactured by screwing a bobbin 20 to a fixed edgewise coil 10 as illustrated, for example, in FIG. 13, and inserting a core 30 into the bobbin 20.

That is, the method for manufacturing a coil component according to this exemplary embodiment is a method for manufacturing the coil component 40 by winding the edgewise coil 10 around the bobbin 20. This method includes: preparing the bobbin 20, which includes: the tubular bobbin body 20a; and the plurality of position-limiting protruding portions arranged in the plurality of portions on the outer peripheral surface of the bobbin body 20a and limiting the position of each winding portion 11 of the edgewise coil 10 in the axial direction of the bobbin body 20a. The plurality of position-limiting protruding portions include a first position-limiting protruding portion and a second position-limiting protruding portion, which are disposed at positions different from each other in the axial direction of the bobbin body 20a. The method further includes winding the edgewise coil 10 around the bobbin 20 by screwing the bobbin 20 and the edgewise coil 10 with each other, in a manner such that: the edgewise coil 10 includes a first winding portion that is in pressure contact with the first position-limiting protruding portion toward the second position-limiting protruding portion and a second winding portion that is in pressure contact with the second position-limiting protruding portion toward the first position-limiting protruding portion; and the edgewise coil 10 is in a state of space winding in which respective winding portions 11 from the first winding portion and the second winding portion are spaced apart from each other in the axial direction of the bobbin body 20a.

Here, when the bobbin 20 and the edgewise coil 10 are screwed with each other, the edgewise coil 10 extends in the axial direction of the bobbin body 20a due to drag that the winding portions 11 of the edgewise coil 10 receives from the plural position-limiting protruding portions. As a result, the first winding portion of the edgewise coil 10 is brought into pressure contact with the first position-limiting protruding portion toward the second position-limiting protruding portion, and the second winding portion of the edgewise coil 10 is brought into pressure contact with the second position-limiting protruding portion toward the first position-limiting protruding portion.

As described above, the winding the edgewise coil 10 around the bobbin 20 is performed while the edgewise coil 10 is being caused to extend in the axial direction of the bobbin body 20a using drag that each of the winding portions 11 of the edgewise coil 10 receives from the plurality of position-limiting protruding portions.

Before the edgewise coil 10 is screwed with the bobbin 20, the edgewise coil 10 may be tightly wound in a manner such that adjacent winding portions 11 are in close contact with each other.

In addition, if there are variations in spaces between winding portions 11 of the edgewise coil 10 before the edgewise coil 10 is screwed with the bobbin 20, these spaces between winding portions 11 can be equalized by limiting positions of the winding portions 11 using the plural position-limiting protruding portions arranged at equal intervals in the axial direction of the bobbin body 20a.

According to the first exemplary embodiment as described above, the first winding portion of the edgewise coil 10 is in pressure contact with the first position-limiting protruding portion toward the second position-limiting protruding portion, and the second winding portion of the edgewise coil 10 is in pressure contact with the second position-limiting protruding portion toward the first position-limiting protruding portion. With this configuration, it is possible to stably determine the positions of the first winding portion and the second winding portion with respect to the first position-limiting protruding portion and the second position-limiting protruding portion, respectively. Thus, it is possible to more stably maintain the positions of each of the winding portions 11 of the edgewise coil 10, and it is possible to more reliably achieve the coil component 40 having a high quality factor.

### Second Exemplary Embodiment

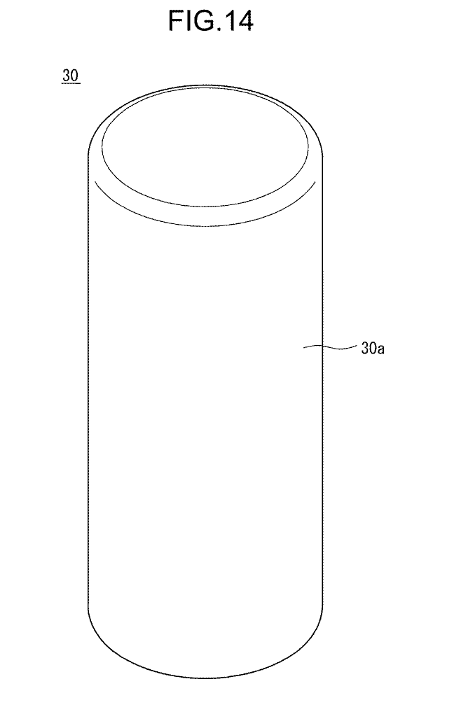

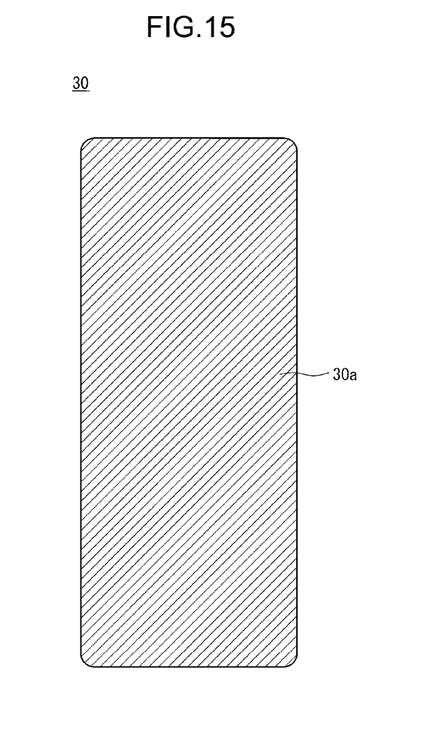

As illustrated in FIGS. 14 and 15, a coil component according to the second exemplary embodiment is different from the coil component 40 according to the first exemplary embodiment in that the core 30 (core body 30a) is formed into a cylindrical column shape (rather than the tubular shape), and in other points, is configured in a similar manner to the coil component 40 according to the first exemplary embodiment.

These are descriptions of each of the exemplary embodiments with reference to the drawings. However, these are merely examples of the present invention, and it may be possible to employ various configurations other than those described above. In addition, it may be possible to combine the exemplary embodiments described above as appropriate without departing from the main points of the present invention.

The present exemplary embodiment includes the following technical ideas.

(1) A coil component, including:

an edgewise coil; and

a bobbin around which the edgewise coil is wound, in which

the bobbin includes:
a tubular bobbin body; and
a plurality of position-limiting protruding portions arranged in a plurality of portions on an outer peripheral surface of the bobbin body and limiting a position of a winding portion of the edgewise coil in an axial direction of the bobbin body,

the plurality of position-limiting protruding portions include a first position-limiting protruding portion and a second position-limiting protruding portion that are disposed at positions different from each other in the axial direction of the bobbin body,

the edgewise coil includes:
a first winding portion that is in pressure contact with the first position-limiting protruding portion toward the second position-limiting protruding portion; and
a second winding portion that is in pressure contact with the second position-limiting protruding portion toward the first position-limiting protruding portion, and

the edgewise coil is in a state of space winding in which respective winding portions from the first winding portion to the second winding portion are spaced apart from each other in the axial direction of the bobbin body.

(2) The coil component according to (1), in which

the position-limiting protruding portions are arranged in a plurality of portions in a circumferential direction of the bobbin body.

(3) The coil component according to (2), in which

a plurality of said position-limiting protruding portions are arranged alongside each other along the axial direction of the bobbin body at each of the plurality of portions in the circumferential direction of the bobbin body.

(4) The coil component according to (2) or (3), in which

the plurality of position-limiting protruding portions are arranged along a spirally shaped path.

(5) The coil component according to any one of (1) to (4), in which

each of the plurality of position-limiting protruding portions has an orthogonal surface orthogonal to the axial direction of the bobbin body, and

the first winding portion is in pressure contact with the orthogonal surface of the first position-limiting protruding portion, while the second winding portion is in pressure contact with the orthogonal surface of the second position-limiting protruding portion.

(6) A method for manufacturing a coil component by winding an edgewise coil around a bobbin, the method including:

preparing a bobbin including:
a tubular bobbin body; and
a plurality of position-limiting protruding portions arranged in a plurality of portions on an outer peripheral surface of the bobbin body and limiting a position of each winding portion of the edgewise coil in an axial direction of the bobbin body,
the plurality of position-limiting protruding portions including a first position-limiting protruding portion and a second position-limiting protruding portion that are disposed at positions different from each other in the axial direction of the bobbin body; and

winding the edgewise coil around the bobbin by screwing the bobbin and the edgewise coil with each other, in a manner such that:
the edgewise coil includes:
   a first winding portion that is in pressure contact with the first position-limiting protruding portion toward the second position-limiting protruding portion; and
   a second winding portion that is in pressure contact with the second position-limiting protruding portion toward the first position-limiting protruding portion, and
the edgewise coil is in a state of space winding in which respective winding portions from the first winding portion to the second winding portion are spaced apart from each other in the axial direction of the bobbin body.
   (7) The method for manufacturing a coil component according to (6), in which

the winding the edgewise coil around the bobbin is performed while the edgewise coil is being caused to extend in the axial direction of the bobbin body using drag that each of the winding portions of the edgewise coil receives from the plurality of position-limiting protruding portions.

This application is based on Japanese Patent Application No. 2017-012701, filed on Jan. 27, 2017, the entire content of which is incorporated hereinto by reference.

What is claimed is:

1. A coil component, comprising:
an edgewise coil; and
a bobbin around which the edgewise coil is wound, wherein
the bobbin comprises:
a tubular bobbin body; and
a plurality of position-limiting protruding portions arranged in a plurality of portions on an outer peripheral surface of the bobbin body and limiting a position of a winding portion of the edgewise coil in an axial direction of the bobbin body,
the plurality of position-limiting protruding portions include a first position-limiting protruding portion and a second position-limiting protruding portion that are disposed at positions different from each other in the axial direction of the bobbin body,
the edgewise coil includes:
a first winding portion that is in pressure contact with the first position-limiting protruding portion toward the second position-limiting protruding portion; and
a second winding portion that is in pressure contact with the second position-limiting protruding portion toward the first position-limiting protruding portion, and
the edgewise coil is in a state of space winding in which respective winding portions from the first winding portion to the second winding portion are spaced apart from each other in the axial direction of the bobbin body.

2. The coil component according to claim 1, wherein
the position-limiting protruding portions are arranged in a plurality of portions in a circumferential direction of the bobbin body.

3. The coil component according to claim 2, wherein
a plurality of said position-limiting protruding portions are arranged alongside each other along the axial direction of the bobbin body at each of the plurality of portions in the circumferential direction of the bobbin body.

4. The coil component according to claim 2, wherein
the plurality of position-limiting protruding portions are arranged along a spirally shaped path.

5. The coil component according to claim 1, wherein
each of the plurality of position-limiting protruding portions has an orthogonal surface orthogonal to the axial direction of the bobbin body, and
the first winding portion is in pressure contact with the orthogonal surface of the first position-limiting protruding portion, while the second winding portion is in pressure contact with the orthogonal surface of the second position-limiting protruding portion.

6. A method for manufacturing a coil component by winding an edgewise coil around a bobbin, the method comprising:
preparing a bobbin including:
a tubular bobbin body; and
a plurality of position-limiting protruding portions arranged in a plurality of portions on an outer peripheral surface of the bobbin body and limiting a position of each winding portion of the edgewise coil in an axial direction of the bobbin body,
the plurality of position-limiting protruding portions including a first position-limiting protruding portion and a second position-limiting protruding portion that are disposed at positions different from each other in the axial direction of the bobbin body; and
winding the edgewise coil around the bobbin by screwing the bobbin and the edgewise coil with each other, in a manner such that:
the edgewise coil includes:
a first winding portion that is in pressure contact with the first position-limiting protruding portion toward the second position-limiting protruding portion; and
a second winding portion that is in pressure contact with the second position-limiting protruding portion toward the first position-limiting protruding portion, and
the edgewise coil is in a state of space winding in which respective winding portions from the first winding portion to the second winding portion are spaced apart from each other in the axial direction of the bobbin body.

7. The method for manufacturing a coil component according to claim 6, wherein
the winding the edgewise coil around the bobbin is performed while the edgewise coil is being caused to extend in the axial direction of the bobbin body using drag that each of the winding portions of the edgewise coil receives from the plurality of position-limiting protruding portions.
